(19) United States
(12) Patent Application Publication
(10) Pub. No.: US 2023/0123565 A1
(43) Pub. Date: Apr. 20, 2023

(54) TRACK MANAGEMENT DEVICE AND METHOD

(71) Applicant: Furuno Electric Co., Ltd., Nishinomiya (JP)

(72) Inventor: Eisuke SEKINE, Vancouver, WA (US)

(21) Appl. No.: 17/450,928

(22) Filed: Oct. 14, 2021

(51) Int. Cl. B63B 79/40; B63H 25/04; G06F 12/0868; G06F 16/29

(52) U.S. Cl. CPC B63B 79/40; B63H 25/04; G06F 12/0868; G06F 16/29; B63H 2025/045

(57) ABSTRACT

A track management device for a movable body includes processing circuitry configured to detect a position of the movable body and determine geographic information of a region surrounding the movable body for displaying on a display, and a memory configured to store track information of the movable body, the track information including a path traversed by the movable body towards a predetermined position, and assign a priority tag to the track information associated with a current path of the movable body, when the movable body is located within a predetermined distance from a predetermined position. The processing circuitry is further configured to generate display information for displaying the track information corresponding to the geographic information on the display.

### TECHNICAL FIELD

The present disclosure mainly relates to a global positioning system (GPS) based marine navigation device that stores information pertaining to tracks traversed by a movable body, and more specifically to automatically displaying the traversed tracks when the movable body approaches a predetermined position which has already been visited before.

### BACKGROUND

An ordinary navigation device has a function to store past tracks, i.e., tracks already traversed by a movable body, in accordance with travel time or travel distance or the combination of both. Each track of the stored past tracks includes a set of position information (i.e., a way-point) with the same time or distance interval. The temperature and/or depth along each track may be displayed along with the past track. The past tracks are displayed on a display in different manners, such as with different colors based on temperature, date, or the like, to enable a user to visit a predetermined position by following an already traversed past track. The already traversed past track is utilized to trace the same route travelled by a movable body, such as a ship, in the past since the past tracks are supposed to be safe routes for navigation of the movable body.

The navigation device includes a memory; however, the memory has a storage capacity limitation. Once the storage capacity of the memory is full, older tracks stored as the past tracks are deleted automatically. If the past track for the previously visited port is deleted automatically, the user might not be able to find and display the past track stored in the memory when they want to approach a previously visited port after a long period of time. Thus, the user encounters unnecessary trouble to approach the previously visited port without information of the past track.

For the aforementioned reasons, there is a need for providing a track management device and method that overcomes the aforementioned problems of the conventional navigation device.

### SUMMARY

In an embodiment of the present disclosure, there is provided a track management device, for a movable body, that includes processing circuitry configured to detect a position of the movable body, and determine geographic information of a region surrounding the movable body for displaying on a display. The track management device further includes a memory configured to store track information of the movable body, the track information including a path traversed by the movable body towards a predetermined position, and assign a priority tag to the track information associated with a current path of the movable body, when the movable body is located within a predetermined distance from the predetermined position. The processing circuitry is further configured to generate display information for displaying the track information corresponding to the geographic information on the display.

Additionally, or optionally, the memory is further configured to automatically store the track information that is assigned the priority tag when the movable body is located within the predetermined distance from the predetermined position.

Additionally, or optionally, the memory is further configured to delete the track information stored without the priority tag in a first-in-first-out (FIFO) manner when a storage capacity of the memory is full.

Additionally, or optionally, the processing circuitry is further configured to generate an indication signal to indicate whether the track information of the movable body associated with the predetermined position is stored in the memory.

Additionally, or optionally, the processing circuitry is further configured to automatically generate the display information for displaying the track information of the movable body associated with the predetermined position when the movable body is located within the predetermined distance from the predetermined position.

Additionally, or optionally, the predetermined distance is set by one of: default and by a user.

Additionally, or optionally, the predetermined position is one of: a port and a harbor.

Additionally, or optionally, the processing circuitry is further configured to generate the display information such that the predetermined position is highlighted on the display when the memory stores the track information associated with the predetermined position.

Additionally, or optionally, the processing circuitry is further configured to obtain speed information of the movable body. The memory is further configured to store the speed information. The processing circuitry is further configured to generate the display information for displaying the speed information along with the track information on the display.

Additionally, or optionally, the processing circuitry is further configured to obtain external disturbance information around the movable body. The memory is further configured to store the external disturbance information. The processing circuitry is further configured to generate the display information for displaying the external disturbance information along with the track information on the display.

Additionally, or optionally, the processing circuitry is further configured to generate the display information for displaying the track information associated with a path having an external disturbance condition similar to an external disturbance condition indicated by the external disturbance information.

Additionally, or optionally, the track management device further comprises a communication module, such as an antenna and a transceiver or a network interface, configured to communicate with a cloud server to obtain past track information associated with a plurality of previous tracks that are uploaded by at least one of the movable body and other movable bodies. The processing circuitry is further configured to selectively receive the past track information associated with a set of previous tracks of the plurality of previous tracks, such that the set of previous tracks are around the detected position of the movable body. The processing circuitry is further configured to generate the display information for displaying the past track information on the display.

Additionally, or optionally, the processing circuitry is further configured to determine the past track information associated with a track selected from the set of tracks. The processing circuitry is further configured to generate the display information such that the past track information for the selected track is highlighted on the display.

In another aspect of the present disclosure, there is provided a track management method. The track management method includes detecting a position of a movable body, determining geographic information of a region surrounding the movable body for displaying on a display, storing track information of the movable body, the track information including a path traversed by the movable body towards a predetermined position, assigning a priority tag to the track information associated with a current path of the movable body, when the movable body is located within a predetermined distance from a predetermined position, and generating display information for displaying the track information corresponding to the geographic information on the display.

In yet another aspect of the present disclosure, there is provided a non-transitory computer readable medium having stored thereon computer-executable instructions which, when executed by a computer, cause the computer to detect a position of a movable body, determine geographic information of a region surrounding the movable body for displaying on a display, store track information of the movable body, the track information including a path traversed by the movable body towards a predetermined position, assign a priority tag to the track information associated with a current path of the movable body, when the movable body is located within a predetermined distance from a predetermined position, and generate display information for displaying the track information corresponding to the geographic information on the display.

The problem of not being able to find and display a past track for a previously visited port that is revisited after a long time for efficient and safe navigation is solved by using a track management device that is configured to selectively store entire tracks or a portion of tracks near predetermined positions, i.e., ports, with a priority tag such that the tracks with the priority tag are not deleted even when the storage capacity of the memory becomes full. Accordingly, the track management device of the present disclosure offers to restore and display the past tracks when approaching the predetermined port and follow the past tracks even when the user revisits the predetermined port after a long time. Additionally, when the user revisits the predetermined port and is within a predetermined distance from the predetermined port, the track management device automatically displays the relevant past tracks around the predetermined port for efficient and safe navigation.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a block diagram illustrating an entire configuration of a track management device for a movable body in which an image sensor is attached to the movable body according to one embodiment of the present disclosure;

FIGS. 2A and 2B illustrate a chart of a region surrounding the movable body; and

FIGS. 3A-3C, collectively, represent a flowchart illustrating a track management method in accordance with an embodiment of the present disclosure.

### DETAILED DESCRIPTION

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

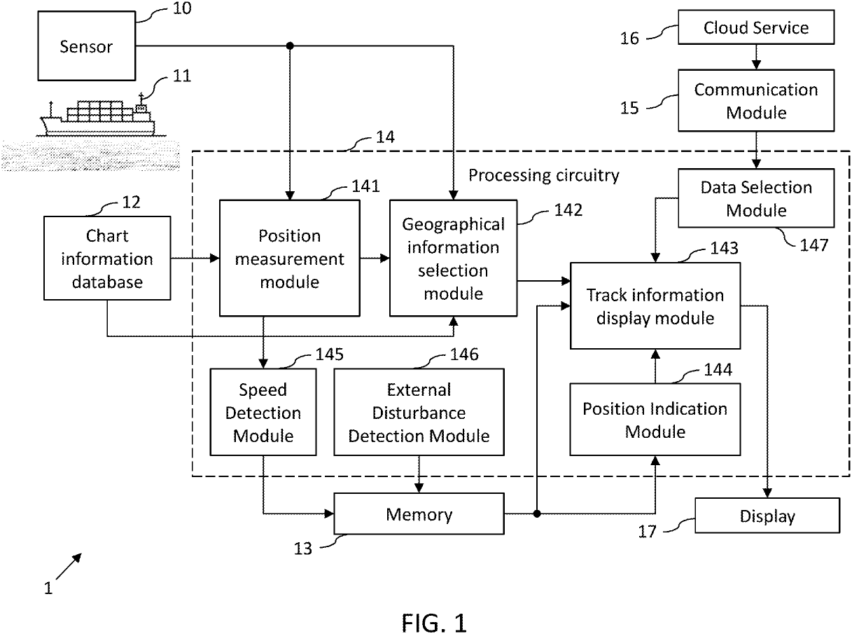

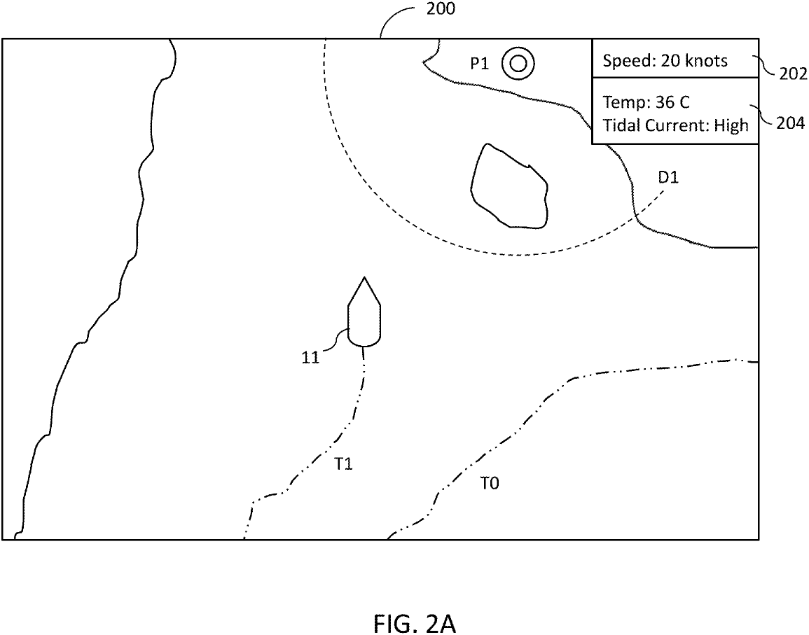

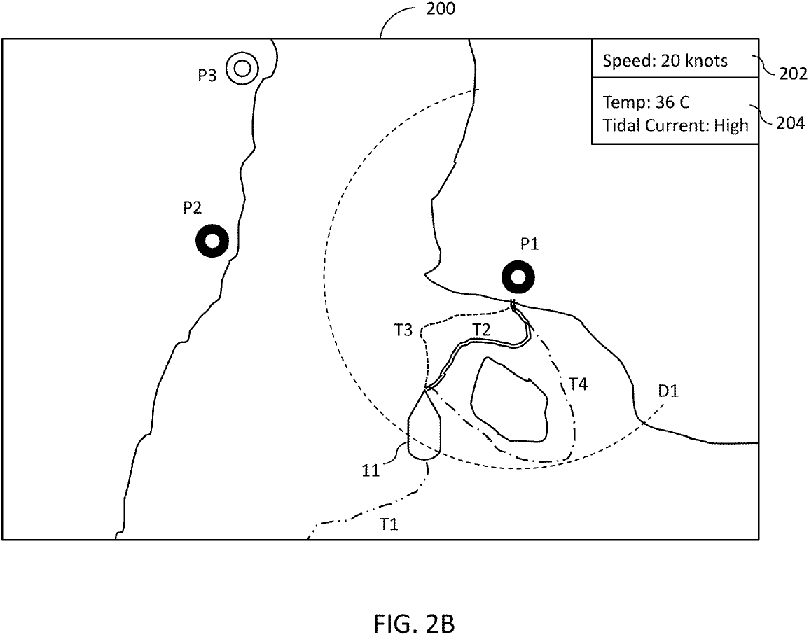

FIG. 1 is a block diagram illustrating an entire configuration of a track management device 1 in which a sensor 10 is attached to a movable body 11 (hereinafter also referred to as a ship 11), according to one embodiment of the present disclosure. FIGS. 2A and 2B illustrate a chart 200 of a region surrounding the movable body 11.

Referring to FIG. 1, the track management device 1 includes the sensor 10, a chart information database 12, a memory 13, processing circuitry 14, a communication module 15, a cloud server 16, and a display 17.

The track management device 1 may be located on-board the ship 11 and provided with, or in electrical connection to, the sensor 10 as the ship instrument for purposes as will be explained in detail later herein. The sensor 10 may be an on-board sensing system such as, but not limited to, a Global Navigation Satellite System (GNSS) receiver, an Electronic Chart Display and Information System (ECDIS), an Automated Identification System (AIS) receiver, a radar device, a sonar, etc.

The sensor 10 may generate position information of the ship 11. The position information corresponds to a track point that is a reference location during navigation of the ship 11. In one embodiment, the sensor 10 generates position information of the ship 11 at regular predefined intervals and/or after regular predefined distance travelled. The position information generated at continuous time intervals forms a track that corresponds to a path traversed by the ship 11. Thus, each track includes multiple track points on the path traversed by the ship 11.

The chart information database 12 may receive and store a global geographical map, or another specified geographical map for a region, based on electronic nautical chart information that may be known beforehand to the chart information database 12. In one embodiment, the chart information database 12 receives and stores a geographical map for a region surrounding the ship 11 determined based on the position information. The position information generated at continuous time intervals by the sensor 10 is marked as track points on the global geographical map or the geographical map for a region surrounding the ship 11. A line connecting all the track points represents the track that corresponds to the path traversed by the ship 11.

The memory 13 stores track information of the ship 11. The track information includes a path traversed by the ship 11 towards a predetermined position. Thus, a track corresponding to the path traversed by the ship 11 from a source towards the predetermined position is stored in the memory 13 as the track information. In one embodiment, the memory 13 stores multiple such tracks corresponding to paths traversed by the ship 11, i.e., based on the navigation of the ship, in the past. The predetermined position is one of, but not limited to, a port and a harbor. In one embodiment, the track information of the ship 11 further includes information such as, but not limited to, depth, tidal current, weather, and time associated with the path traversed by the ship 11. The memory 13 is, for example, a non-volatile memory, such as, a read-only memory (ROM), an erasable programmable ROM (EPROM), an electrically erasable programmable ROM (EEPROM), ferroelectric random-access memory (RAM), and the like.

The processing circuitry 14 is operably coupled with the memory 13 and retrieves the track information from the memory 13. The processing circuitry 14 generates display information for displaying the track information on the display 17. Referring now to FIG. 2A, the chart 200 that illustrates the region surrounding the ship 11 is displayed on the display 17. The track information displayed on the display 17 includes tracks T0 and T1. In one embodiment, the track T0 corresponds to a path previously traversed by the ship 11 in the past and the track T1 corresponds to a path currently traversed by the ship 11. The display 17 further displays a port P1 on the chart 200. In one embodiment, the port P1 is the predetermined position and the memory 13 stores the track information including the path traversed by the ship 11 towards the port P1, i.e., the track T1.

Although, the memory 13 is shown to be external to the processing circuitry 14, it would be apparent to one of ordinary skill in the art, that the memory 13 may be an integral part of the processing circuitry 14. In the context of the present disclosure, the processing circuitry 14 includes a processor, computer, microcontroller, or other circuitry that controls the operations of various components such as the memory 13. The processing circuitry 14 may execute software, firmware, and/or other instructions, for example, that are stored on a volatile or non-volatile memory, or otherwise provided to the processing circuitry 14. The processing circuitry 14 is, for example, a microprocessor, a controller, a microcontroller, a state machine, an application specific integrated circuit (ASIC), a field programmable gate array (FPGA), a digital signal processor, or a combination thereof.

The track management device 1 may be provided with, or be communicatively coupled to, the display 17 for displaying the chart 200 expressing the situation around the movable body 11, among other things, a detected position of the ship 11 as will be explained later herein, and various tracks on the region surrounding the ship 11. The chart 200 may be one of, but not limited to, a vector chart or a raster chart.

The display 17 may be configured as, for example, a display that forms part of a navigation assisting device to which a ship operator who operates the ship 11 refers. However, the display 17 is not limited to the above configuration, and, for example, it may be a display for a portable computer which is carried by a ship operator’s assistant who monitors the surrounding situation from the ship 11, a display for a passenger to watch in the cabin of the ship 11, or a display part for a head mounted display, such as a wearable glass, worn by a passenger.

Although, the sensor 10 and the display 17 are shown to be an integral part of the track management device 1, it would be apparent to one of ordinary skill in the art, that the sensor 10 and the display 17 may be external to the track management device 1. The sensor 10, the display 17, and the track management device 1 may integrally form a navigation apparatus that autonomously, or at least semi-autonomously facilitates a user to, navigate the ship 11 across the sea. The navigation apparatus enables the user to navigate the ship 11 by displaying the track information in a manner which is easy for a user to comprehend.

The track management device 1 may also be connected to variety of peripheral devices including, but not limited to, a keyboard and a mouse which the user may operate for performing various functions pursuant to functionalities in the present disclosure. For example, the user can provide various kinds of instructions to the track management device 1 about generation of the chart 200, storage of the track information, and the like by operating the keyboard and/or the mouse.

With continued reference to FIG. 1, the processing circuitry 14 includes a position measurement module 141, a geographical information selection module 142, a track information display module 143, a position indication module 144, a speed detection module 145, an external disturbance detection module 146, and a data selection module 147.

The position measurement module 141 detects a current position of the ship 11. To do so, the position measurement module 141 may receive the position information of the ship 11 from the sensor 10. The position measurement module 141 detects the current position of the ship 11 via any external equipment, for example, a land station or the sensor 10 based on the position information.

The geographical information selection module 142 is operably coupled with the chart information database 12, hence in communication with the chart information database 12. The geographical information selection module 142 determines geographic information of a region surrounding the ship 11 based on the geographical map for the region surrounding the ship 11 and the detected position of the ship 11. The geographic information is to be displayed on the display 17.

When the ship 11 is located within the predetermined distance from the predetermined position, the memory 13 assigns a priority tag to the track information associated with a current path of the ship 11 and stores the track information with the priority tag. In one example, the track information associated with the entire track, i.e., the current path from a beginning of a journey of the ship 11 till it reaches the predetermined position, i.e., the port P1, is assigned the priority tag and stored in the memory 13. In another example, the track information associated with a portion of the track, i.e., the current path from a position when the ship 11 is located within the predetermined distance till it reaches the predetermined position, i.e., the port P1, is assigned the priority tag and stored in the memory 13. In the latter example, the track information including the path from the beginning of the journey till the position when the ship 11 is located within the predetermined distance, is not assigned the priority tag.

In one embodiment, the track information with the priority tag, is automatically stored in the memory 13 when the ship 11 is located within the predetermined distance from the predetermined position, i.e., the track information is stored without any input from the user. In another embodiment, the track information with the priority tag, is stored in the memory 13 upon receiving an input from the user, when the ship 11 is located within the predetermined distance from the predetermined position. For example, the user can provide instruction to the track management device 1 about storing of the entire track or the portion of the track with or without the priority tag by operating the keyboard and/or the mouse.

Referring now to FIGS. 1, 2A, and 2B, the track information display module 143 is operably coupled to the geographical information selection module 142 and the memory 13, and receives the geographic information and the track information. The track information display module 143 generates the display information for displaying the track information on the display 17. The track information is displayed on the chart 200 displayed on the display 17 corresponding to the geographic information, i.e., all the tracks in the region represented by the geographic information are displayed on the display 17.

The position indication module 144 generates an indication signal to indicate whether the track information of the ship 11 associated with the predetermined position is stored in the memory 13. The track information associated with the predetermined position correspond to all the tracks traversed by the ship 11 in the past to reach the predetermined position. In one embodiment, to generate the indication signal, the position indication module 144 retrieves the track information from the memory 13 and determines whether the track information associated with significant positions, such as ports P1-P3, in the region surrounding the ship 11 is stored in the memory 13. Based on the determination, the position indication module 144 generates the indication signal to indicate whether the track information associated with the significant positions is stored in the memory 13. In one example, when the track information associated with the predetermined position is stored in the memory 13, the position indication module 144 generates the indication signal at logic high level, and when the track information associated with the predetermined position is not stored in the memory 13, the position indication module 144 generates the indication signal at logic low level.

When the ship 11 is located within the predetermined distance, i.e., a distance D1, from the predetermined location, i.e., the port P1, that was previously visited, the indication signal indicates whether the track information associated with the port P1 is stored in the memory 13. If the indication signal indicates that the track information associated with the predetermined position is stored, the track information display module 143 automatically generates the display information for displaying the track information of the ship 11 associated with the predetermined position. In one embodiment, when the ship 11 is within the predetermined distance D1 from the first port P1, tracks T2-T4 are automatically displayed on the display 17 as shown in FIG. 2B. In one embodiment, the tracks T2-T4 are displayed as routes for navigation of the ship 11 to reach the port P1. Each route includes multiple waypoints corresponding to the multiple track points of respective tracks. Thus, the user is able to follow one of the tracks T2-T4 traversed by the ship 11 previously as a route for navigation to reach the port P1 for efficient and safe navigation.

The chart 200 is displayed for displaying the ship 11, the track information associated with various tracks, such as T1 (current path) and T2-T4 associated with the port P1, such that the tracks T2-T4 are automatically displayed when the ship 11 is located within the predetermined distance D1 from the first port P1. The ship 11 is shown on the chart 200 at the detected position of the ship 11 by the position measurement module 141. Further, the chart 200 is displayed for displaying other ports, such as ports P2 and P3, on the geographical map of the region surrounding the ship 11. Thus, in FIG. 2A when the ship 11 is not located within the distance D1 of the port P1, the tracks T2-T4 are not shown, and in FIG. 2B when the ship 11 reaches within the distance D1 of the port P1, the tracks T2-T4 are automatically shown.

In one embodiment, when the memory 13 stores the track information associated with the predetermined position, the display information is generated such that the predetermined position, i.e., such as the port P1, is highlighted on the display 17. In one embodiment, the memory 13 stores the track information associated with the ports P1 and P2 and does not store the track information associated with the port P3. Thus, the ports P1 and P2 are highlighted and the port P3 is not highlighted on the display 17, as shown in FIG. 2B. In one embodiment, the ports P1 and P2 may be highlighted by utilizing one of a different color, a different shape, a pop-up, blinking icon, and the like, to indicate the user that track information associated with the corresponding ports is stored in the memory 13.

The speed detection module 145 obtains speed information of the ship 11. In one embodiment, the speed detection module 145 is operably coupled to, and hence in communication with, the position measurement module 141, and obtains speed information of the ship 11 based on the detected position of the ship 11 at various time instances. The memory 13 further stores the speed information. The track information display module 143 retrieves the speed information from the memory 13 and the display information further includes the speed information to be displayed along with the track information on the display 17. In one embodiment, the speed information is displayed on the display 17 in a display area 202, as shown in FIGS. 2A and 2B.

The external disturbance detection module 146 obtains external disturbance information around the ship 11. In one embodiment, the sensor 10 includes one or more sensors to detect external disturbances such as the weather conditions, the tidal current conditions, and the like. The one or more sensors are in communication with the external disturbance detection module 146 to provide the detected external disturbances based on which the external disturbance information is obtained. The memory 13 further stores the external disturbance information. The display information further includes the external disturbance information to be displayed along with the track information on the display 17. In one embodiment, the external disturbance information is displayed on the display 17 in the display area 204, as shown in FIGS. 2A and 2B.

Additionally, or optionally, the display information is generated such that the tracks T2-T4 are displayed on the chart 200 with different visual characteristics, such as colors and/or lines, based on the external disturbance information associated with each track. In one embodiment, the different visual characteristics of the tracks may be specified by the user. In another embodiment, the different visual characteristics of the tracks may be displayed by default based on predefined configuration.

In one embodiment, the track information display module 143 further generates the display information for displaying the track information associated with a track having an external disturbance condition similar to an external disturbance condition indicated by the external disturbance information. For example, when the external disturbance information indicates that the tidal current condition in the vicinity of the ship 11 is high, the display information includes the track information associated with a track having the tidal current condition as high. In one example, out of the tracks T2-T4, if the track T3 is associated with the external disturbance information that indicates tidal current as high, the display information is generated such that the track T3 is highlighted on the display 17 for navigating to the port P1.

The memory 13 deletes the track information stored without the priority tag in a first-in-first-out (FIFO) manner when a storage capacity of the memory 13 is full. In other words, the track information without the priority tag stored in the memory 13 first would be deleted first and when the storage capacity of the memory 13 is full. Thus, the track information stored in the memory 13 with the priority tag will not be deleted until the storage capacity of memory 13 is full and there is no track information without the priority tag that can be deleted to free up the storage capacity. As a result, the user might be able to save tracks associated with important ports and harbors, and navigate the ship 11 safely to the important ports and harbors even if the user revisits after long time intervals.

Additionally, or optionally, the track management device 1 includes the communication module 15 that communicates with a cloud server 16 to obtain past track information associated with a plurality of tracks. The plurality of tracks are uploaded by at least one of the ship 11 and other movable bodies. In one embodiment, the past track information associated with the plurality of tracks stored in the memory 13 of the track management device 1 of the ship 11 are uploaded on the cloud server 16 to free up the storage capacity of the memory 13. In one example, when the memory 13 does not include the track information associated with port P1 or the track information associated with the port P1 is deleted, the track information display module 143 displays the tracks T2-T4 based on the past track information.

The data selection module 147 selectively receives the past track information associated with a set of tracks of the plurality of tracks from the cloud server 16 by way of the communication module 15, such that the set of tracks are around the location of the ship 11. The display information further includes the past track information obtained from the cloud server 16 by the data selection module 147 to be displayed on the display 17.

In one embodiment, the data selection module 147 determines the past track information associated with a track selected from the set of tracks by the majority rule. In one example, the majority rule may correspond to selection of a track that is travelled by majority of ships or majority of times by different ships to reach the predetermined position. The display information is generated such that the determined past track information for the selected track is highlighted on the display 17.

It will be apparent to a person skilled in the art that along with the track information, the speed information, the external disturbance information, the display information may be generated for displaying other characteristics of the region surrounding the ship 11, such as depth information, tidal current speed at predetermined position, and the like.

A scope of the on-board ship equipment (information source for the position measurement module 141 and/or the geographical information selection module 142) of the track management device 1 is not limited to any of the configurations that have been disclosed herein, and other types of instruments may be included to form part of the on-board ship equipment without limiting the scope of the present disclosure.

Further, the present disclosure is applicable not only to the ship which travels on the sea, but may also be applicable to arbitrary water-surface movable bodies which can travel, for example, on a lake, or a river.

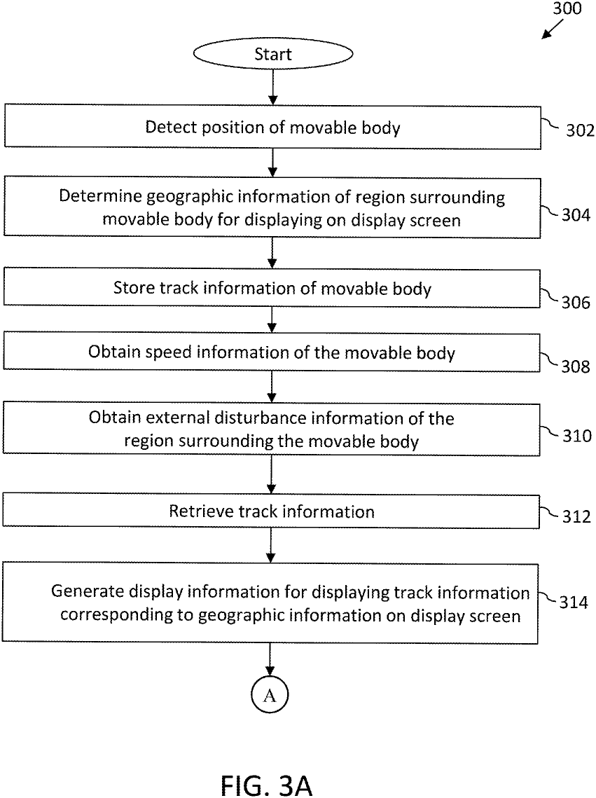

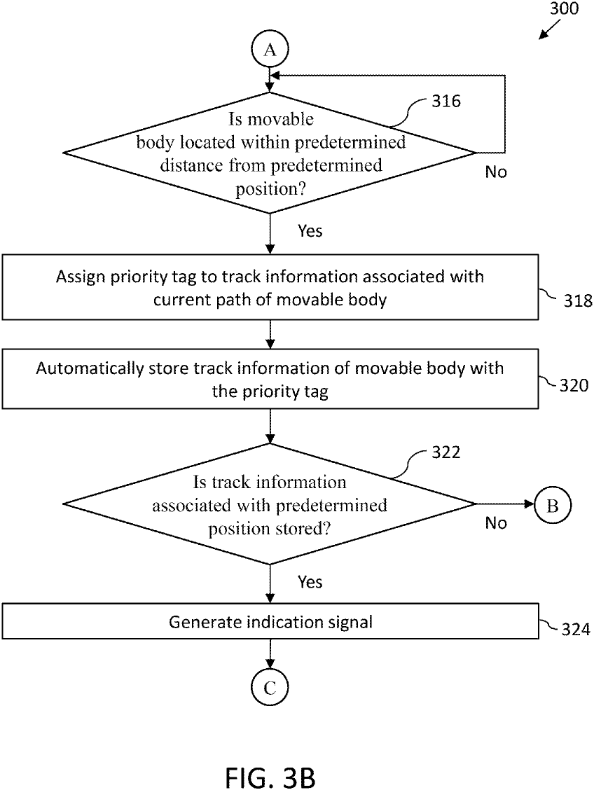

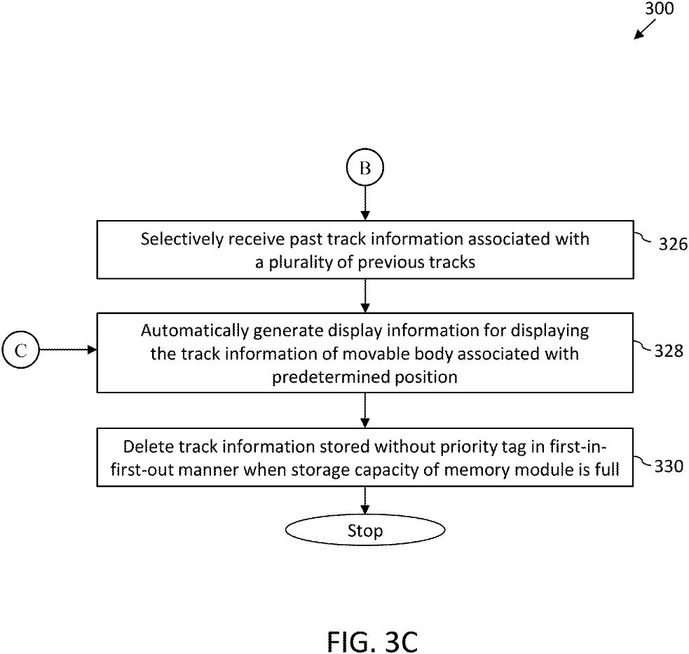

FIGS. 3A-3C represent a flowchart illustrating a track management method 300 in accordance with an embodiment of the present disclosure.

At step 302, the position measurement module 141 detects the position of the movable body 11. The position measurement module 141 detects the position of the ship 11 based on the position information from the sensor 10.

At step 304, the geographical information selection module 142 determines the geographic information of the region surrounding the ship 11 for displaying on the display 17. The geographic information displayed on the display 17 corresponds to the chart 200.

At step 306, the memory 13 stores track information of the movable body 11. The track information including the path traversed by the movable body 11 towards the predetermined position.

At step 308, the speed detection module 145 obtains the speed information of the movable body 11 based on the detected position of the movable body 11 at various time instances. At step 310, the external disturbance information module 146 obtains the external disturbance information based on the detected external disturbances. The speed information and the external disturbance information are stored in the memory 13.

At step 312, the track information display module 143 retrieves the track information from the memory 13. The track information display device 143 further retrieves the speed information and the external disturbance information from the memory 13

At step 314, the track information display module 143 is further configured to generate display information for displaying the track information corresponding to the geographic information on the display 17.

At step 316, the processing circuitry 14 determines whether the movable body 11 is located within the predetermined distance from the predetermined position. If at step 316, the processing circuitry 14 determines that the movable body 11 is located within the predetermined distance from the predetermined position, step 318 is executed. If at step 316, the processing circuitry 14 determines that the movable body 11 is not located within the predetermined distance from the predetermined position, step 316 is executed again.

At step 318, the memory 13 assigns the priority tag to the track information associated with the current path of the movable body 11. At step 320, the memory 13 automatically stores the track information of the movable body 11 with the priority tag.

At step 322, the position indication module 144 determines whether the track information associated with the predetermined position is stored in the memory 13. If at step 322, the position indication module 144 determines that the track information associated with the predetermined position is stored, step 324 is executed. At step 324, the position indication module 144 generates the indication signal to indicate that the track information associated with the predetermined position is stored in the memory 13.

If at step 322, the position indication module 144 determines that the track information associated with the predetermined position is not stored, step 326 is executed. At step 326, the data selection module 147 selectively receives the past track information associated with the plurality of tracks from the cloud server 16 by way of the communication module 15. After steps 324 and 326, step 328 is executed.

At step 328, the track information display device 143 automatically generates the display information for displaying the track information of the movable body 11 associated with the predetermined position when the movable body 11 is located within the predetermined distance from the predetermined position.

At step 330, the memory 13 deletes the track information stored without the priority tag in a first-in-first-out (FIFO) manner when the storage capacity of the memory 13 is full.

### TERMINOLOGY

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10%) of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A track management device for a movable body, comprising:
processing circuitry configured to:
detect a position of the movable body; and
determine geographic information of a region surrounding the movable body for displaying on a display; and
a memory configured to:
store track information of the movable body, the track information including a path traversed by the movable body towards a predetermined position; and
assign a priority tag to the track information associated with a current path of the movable body, when the movable body is located within a predetermined distance from the predetermined position, wherein
the processing circuitry is further configured to generate display information for displaying the track information corresponding to the geographic information on the display.

2. The track management device of claim 1, wherein the memory is further configured to automatically store the track information that is assigned the priority tag when the movable body is located within the predetermined distance from the predetermined position.

3. The track management device of claim 1, wherein the memory is further configured to delete the track information stored without the priority tag in a first-in-first-out (FIFO) manner when a storage capacity of the memory is full.

4. The track management device of claim 1, wherein the processing circuitry is further configured to generate an indication signal to indicate whether the track information of the movable body associated with the predetermined position is stored in the memory.

5. The track management device of claim 4, wherein the processing circuitry is further configured to automatically generate the display information for displaying the track information of the movable body associated with the predetermined position when the movable body is located within the predetermined distance from the predetermined position.

6. The track management device of claim 1, wherein the predetermined distance is set by one of: default and by a user.

7. The track management device of claim 1, wherein the predetermined position is one of: a port and a harbor.

8. The track management device of claim 1, wherein the processing circuitry is further configured to generate the display information such that the predetermined position is highlighted on the display when the memory stores the track information associated with the predetermined position.

9. The track management device of claim 1, wherein
the processing circuitry is further configured to obtain speed information of the movable body;
the memory is further configured to store the speed information; and
the processing circuitry is further configured to generate the display information for displaying the speed information along with the track information on the display.

10. The track management device of claim 1, wherein
the processing circuitry is further configured to obtain external disturbance information around the movable body;
the memory is further configured to store the external disturbance information; and
the processing circuitry is further configured to generate the display information for displaying the external disturbance information along with the track information on the display.

11. The track management device of claim 10, wherein
the processing circuitry is further configured to generate the display information for displaying the track information associated with a path having an external disturbance condition similar to an external disturbance condition indicated by the external disturbance information.

12. The track management device of claim 1, further comprising:
a network interface configured to communicate with a cloud server to obtain past track information associated with a plurality of previous tracks that are uploaded by at least one of the movable body and other movable bodies, wherein
the processing circuitry is further configured to selectively receive the past track information associated with a set of previous tracks of the plurality of previous tracks, such that the set of previous tracks are around the detected position of the movable body, and
the processing circuitry is further configured to generate the display information for displaying the past track information on the display.

13. The track management device of claim 12, wherein
the processing circuitry is further configured to determine the past track information associated with a track selected from the set of tracks, and
the processing circuitry is further configured to generate the display information such that the past track information for the selected track is highlighted on the display.

14. A track management method, comprising:
detecting a position of a movable body;
determining geographic information of a region surrounding the movable body for displaying on a display;
storing track information of the movable body, the track information including a path traversed by the movable body towards a predetermined position;
assigning a priority tag to the track information associated with a current path of the movable body, when the movable body is located within a predetermined distance from a predetermined position; and
generating display information for displaying the track information corresponding to the geographic information on the display.

15. The track management method of claim 14, further comprising:
automatically storing track information that is assigned the priority tag when the movable body is located within the predetermined distance from the predetermined position.

16. The track management method of claim 14, further comprising:
deleting the track information stored without the priority tag in a first-in-first-out (FIFO) manner when a storage capacity of the memory is full.

17. The track management method of claim 14, further comprising:
generating an indication signal to indicate whether the track information of the movable body associated with the predetermined position is stored; and
automatically generating the display information for displaying the track information of the movable body associated with the predetermined position when the movable body is located within the predetermined distance from the predetermined position.

18. The track management method of claim 14, wherein the predetermined distance is set by one of: default and by a user.

19. The track management method of claim 14, wherein the predetermined position is one of: a port and a harbor.

20. A non-transitory computer readable medium having stored thereon computer-executable instructions which, when executed by a computer, cause the computer to:
detect a position of a movable body;
determine geographic information of a region surrounding the movable body for displaying on a display;
store track information of the movable body, the track information including a path traversed by the movable body towards a predetermined position;
assign a priority tag to the track information associated with a current path of the movable body, when the movable body is located within a predetermined distance from a predetermined position; and
generate display information for displaying the track information corresponding to the geographic information on the display.
